(19) United States
(12) Patent Application Publication
(10) Pub. No.: US 2007/0298253 A1
(43) Pub. Date: Dec. 27, 2007

(54) Transparent Conductive Carbon Nanotube Film and a Method for Producing the Same

(76) Inventors: Kenji Hata, Ibaraki (JP); Sumio Iijima, Ibaraki (JP); Motoo Yumura, Ibaraki (JP); Don N. Futaba, Ibaraki (JP)

Correspondence Address: WENDEROTH, LIND & PONACK, L.L.P., 2033 K STREET N. W., SUITE 800, WASHINGTON, DC, 20006-1021, US

(21) Appl. No.: 11/663,061

(22) PCT Filed: Sep. 16, 2005
(86) PCT No.: PCT/JP05/17549

§ 371 Date: Jun. 18, 2007

(30) Foreign Application Priority Data
Sep. 17, 2004 (JP) 2004-271645

(51) Int. Cl. C01B 31/02; C08J 5/18; H01B 13/00; H01B 5/14

(52) U.S. Cl. 428/339; 118/56; 427/240; 427/249.1; 427/428.01; 427/430.1

(57) ABSTRACT

A transparent conductive film wherein carbon nanotubes are discursively embedded in the surface portion of a resin film is produced by (A) dispersing carbon nanotubes on a substrate surface, (B) forming a transparent resin film over the substrate on which the carbon nanotubes are dispersed, and then (C) separating the thus-formed resin film. This is a novel technique for realizing a highly transparent conductive film which is flexible and highly conductive even when amount of carbon nanotubes used therefor is small.

### TECHNICAL FIELD

The present invention relates to a novel carbon nanotube film having high electrical conductivity, as well as transparency and flexibility, by using a small amount of carbon nanotubes, and a method of producing the same, and its application.

### BACKGROUND ART

The progress of technological development for carbon nanotubes as a novel functional material has been drawing attention to their use as a conductive or similar electrical or electronic material. For example, as carbon nanotubes are a nanoscale material, a study has been made of using them as an electrically conductive material and employing a flexible resin film as a substrate therefor (reference is made to, for example, Non-Patent Literature 1).

However, it has been a drawback of a known carbon nanotube conductive material employing a resin film that no good conductivity can be obtained unless a large amount of carbon nanotubes are dispersed in a molded film, and it has been another drawback that no resin film conductive material of high transparency can be obtained if it contains a large amount of carbon nanotubes. For example, a carbon nanotube-containing resin film according to Non-Patent Literature 1 as mentioned above has an electrical conductivity of 10⁻⁸ S/cm and a light transmittance of 68% and is not a resin film which is fully satisfactory in both conductivity and transparency, but its further improvement is actually desired.
Non-Patent Literature 1: Cheol Park et al., Chemical Physics Letters 364 (2002), 303

### DISCLOSURE OF THE INVENTION

In view of the background as described above, it is an object of the present invention to provide novel technological means making it possible to realize a highly conductive, soft and flexible and highly transparent conductive film even by using a small amount of carbon nanotubes.

The present invention is characterized by the following as a solution to the object as stated above:

[1] (A) Carbon nanotubes are dispersed on a substrate surface, (B) a transparent resin film is formed on the substrate surface on which the carbon nanotubes have been dispersed, and (C) the resin film which has been formed is separated to produce a conductive carbon nanotube film having the carbon nanotubes enclosed and embedded by dispersion or as a layer only in the surface portion of the resin film.

[2] The dispersion of the carbon nanotubes on the substrate surface by step (A) is carried out by at least one of the methods of growing, plating or scattering carbon nanotubes on the substrate surface, or casting a dispersion of carbon nanotubes.

[3] The forming of the resin film by step (B) is carried out by at least one of the methods of spin coating, roll coating, dip or like coating, or vapor-phase film forming.

[4] The carbon nanotubes are single-walled carbon nanotubes.

[5] A manufacturing apparatus for any of the methods as set forth above, comprising a carbon nanotube substrate forming portion for dispersing carbon nanotube on the substrate surface, a film forming portion for forming a resin film on the carbon nanotube substrate surface having the carbon nanotubes dispersed thereon and a film separating portion for separating the resin film which has been formed.

[6] In a conductive film having carbon nanotubes enclosed and embedded by dispersion or as a layer only in the surface portion of a resin film, a conductive carbon nanotube film having a high conductivity as indicated by a surface resistance of or below 100 kΩ/□ in its surface portion which has the carbon nanotubes enclosed and embedded therein.

[7] In the film as set forth above, the surface portion having the carbon nanotubes enclosed and embedded therein by dispersion has a resistance below 10 kΩ/□.

[8] A conductive carbon nanotube film having a high transparency as indicated by a light transmittance (visible light) of 80% or above.

[9] The surface portion having carbon nanotubes enclosed and embedded therein by dispersion has a maximum thickness (t) expressed as t/T<10% in relation to the maximum thickness (T) of the whole film.

[10] The carbon nanotubes are single-walled carbon nanotubes.

[11] It is perfectly flexible.

[12] It can withstand 100 or more perfect flexions in a flexing test.

[13] When it is perfectly flexed, the electrical resistance of the surface portion having the carbon nanotubes enclosed and embedded therein does not vary at all, or to any extent exceeding 10%.

[14] When a Scotch tape peeling test is conducted, the electrical resistance of the surface portion having the carbon nanotubes enclosed and embedded therein does not vary at all, or to any extent exceeding 10%, and the carbon nanotubes enclosed and embedded therein by dispersion are high in adhesive strength.

[15] In any of the conductive carbon nanotube films as set forth above, the surface portion of the resin film having the carbon nanotubes enclosed and embedded therein by dispersion is defined in a patterned planar area in the whole plane of the resin film.

[16] A conductive carbon nanotube film composed of a multiplicity of layers including at least one layer formed by any of the conductive carbon nanotube films as set forth above.

[17] A conductive carbon nanotube film in which layers having carbon nanotubes dispersed and embedded therein are stacked opposite each other so as to sandwich a resin layer not having any carbon nanotube dispersed and embedded therein.

[18] A conductive material having at least a part of its structure formed by any of the conductive carbon nanotube films as set forth above.

[19] A flexible conductive material having flexibility.

[20] A heating element having at least a part of its structure formed by any of the conductive carbon nanotube films as set forth above.

[21] A flexible heating element having flexibility.

[22] A touch panel having at least a part of its structure formed by any of the conductive carbon nanotube films as set forth above

[23] A flexible touch panel having flexibility.

### BRIEF DESCRIPTION OF THE DRAWINGS

FIG. 1 is a schematic illustration showing a method of the present invention for manufacturing a transparent conductive carbon nanotube film and a manufacturing method according to the prior art, and comparing their features.

FIG. 2 is (a) a diagrammatic cross-sectional illustration of a laminated conductive carbon nanotube film according to the present invention, and (b) a diagrammatic cross-sectional illustration of another form of laminated conductive carbon nanotube film.

FIG. 3 gives atomic force microscope images showing the surface of a transparent conductive carbon nanotube film and the state of carbon nanotubes as observed in various steps of a process for preparing a transparent conductive carbon nanotube film according to Example 1. (a) An atomic force microscope image showing the state of carbon nanotubes distributed on a substrate by step (A). (b) An atomic force microscope image showing the surface as observed of a resin film separated by step (C). (c) An atomic force microscope image showing the surface as observed of the substrate separated by step (C).

FIG. 4 is a diagram showing the surface resistance of the transparent conductive carbon nanotube film according to Example 1 in relation to its flexion.

FIG. 5 is a diagram showing the visible light transmittance of the transparent conductive carbon nanotube film which has a surface resistivity of 20 kΩ/□ according to Example 1.

FIG. 6 is a diagram showing the electrical transport property up to 40 V of the transparent conductive carbon nanotube film of 2 cm square according to Example 1.

FIG. 7 is a diagram showing the appearance of SWCNT conductive films formed from various resins as shown in Example 2.

FIG. 8 is a diagram showing by way of example the light transmission characteristics of the SWCNT-PVC conductive film according to Example 2.

FIG. 9 is a diagram showing by way of example the electrical transport property of the SWCNT-PVC conductive film according to Example 2.

FIG. 10 is a diagram showing the atomic force microscope images and Raman spectra of a PVC conductive film as formed and as separated.

FIG. 11 is a schematic illustration showing the flexing (bending) test employed in Example 3.

FIG. 12 is a diagram illustrating the relation between the bending radius (r) of the SWCNT-PVC conductive film and its surface resistance according to Example 3.

FIG. 13 is a diagram showing the relation between the number of repeated flexions and a change in resistance.

FIG. 14 is a schematic illustration and a photogram showing an example of tough panel construction.

FIG. 15 is a diagram illustrating the temperature and resistance dependence of a heater example on the voltage applied thereto.

The symbols in the drawings denote the following:

1—Portion containing carbon nanotubes;

2—Portion not containing carbon nanotubes.

### BEST MODE OF CARRYING OUT THE INVENTION

The present invention has the features as stated above and a mode of carrying it out will now be described.

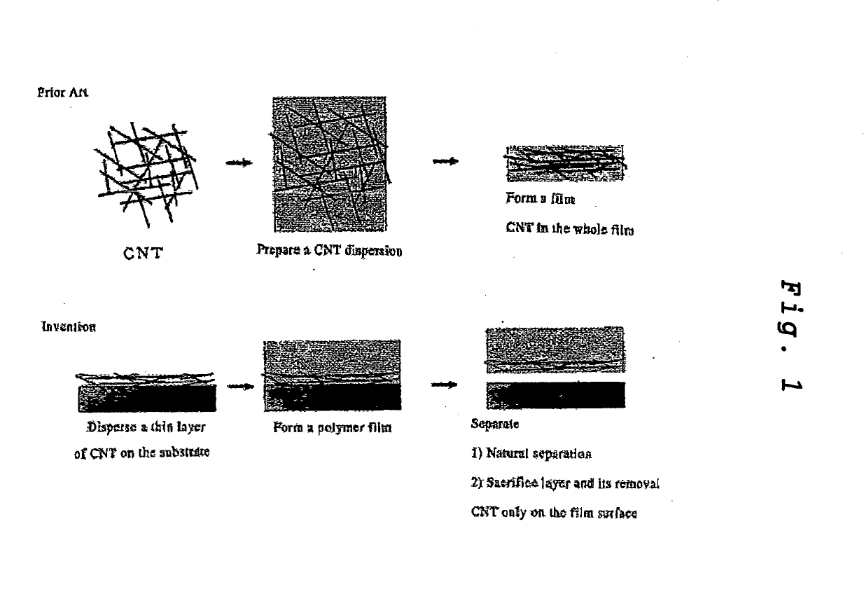

According to the method of the present invention for manufacturing a transparent conductive carbon nanotube film, (A) carbon nanotubes are dispersed on a substrate surface, (B) a transparent resin film is formed on the substrate surface on which the carbon nanotubes have been dispersed, and (C) the resin film which has been formed is separated to produce a conductive film having the carbon nanotubes enclosed and embedded by dispersion or as a layer only in the surface portion of the resin film. FIG. 1 is a general illustration of those features for their comparison with a customary method.

As shown in FIG. 1 by way of example, a film is customarily formed by using a resin film forming solution in which carbon nanotubes (CNT's) are dispersed, and as CNT's are dispersed throughout the whole film which has been formed, it is impossible to position carbon nanotubes (CNT's) as a network or layer thereof selectively in only the surface portion of the resin film which has been formed. As a natural consequence, even the use of a large amount of CNT's necessarily results in little bonding of CNT's and makes it difficult to obtain improved conductivity. Moreover, the presence of a large amount of CNT's results in a lowering of transparency. On the other hand, the method of the present invention naturally enables even a small amount of CNT's to realize a high degree of CNT bonding and a high conductivity, since CNT's are enclosed and embedded by integration with the resin in the distributed state in a mutual network only in the surface portion of the film, in a similar state or a denser state, i.e. by integration in an inseparable way by the impregnation and solidification of the resin in the above network or layer, so that they may be present only in the surface portion of the resin film. Moreover, the sufficiency of a small amount of CNT's enables a high transparency.

Referring to the meaning of “enclose and embed” in the context of the present invention, it does not mean the adsorption or adhesion of carbon nanotubes (CNT's) to the surface of the resin film.

It means that CNT's in a dispersed state are wholly or at least partly enclosed in the resin and embedded in the surface portion of the resin film to obtain an embedded and integrally united state. Embed includes the state in which CNT's have their surfaces partly exposed outside.

Although any of various means may be employed for step (A) in the present invention having the features as stated above, the dispersion of the carbon nanotubes on the substrate surface by step (A) is preferably carried out by at least one of the methods of growing, plating or scattering carbon nanotubes on the substrate surface, or casting a dispersion of carbon nanotubes thereon. The growing of carbon nanotubes on the substrate surface may be carried out by chemical vapor-phase synthesis. Their plating is carried out by applying an electric field in a carbon nanotube dispersion by means of two electrodes (usually parallel flat plates), so that the electric field may cause the carbon nanotubes to migrate through the solution and thereby be deposited on the substrate placed at a predetermined site.

Although various means may be employed for step (B), too, the forming of the resin film by step (B) is preferably carried out by at least one of the methods of spin coating, roll coating, dip or like coating, or vapor-phase film forming.

Various means may also be employed for the separation by step (C), i.e. the peeling of the resin film having the carbon nanotubes enclosed and embedded by the so-called transfer. It is possible to employ means, for example, mechanical peeling or etching with a chemical substance. If its peeling has caused the adherence of any sacrificed layer from the substrate, it has to be removed. It is possible to use any of various cleansing or etching agents.

In steps (A), (B) and (C) as described above, the substrate is preferably of the nature not causing any change in quality or deterioration of the resin film to be formed, but making its separation by step (C) relatively easy.

For such a substrate, it is possible to employ anything appropriate, for example, Si (silicon) or similar semiconductor, a metal, an alloy, or oxide, carbide, nitride or composite oxide or similar ceramics, or an inorganic substance. It may also be a separable resin, or a composite of a resin, a metal and ceramics. The polymer composing the resin film may be a synthetic or natural one, or a mixture thereof, and may be of the type which undergoes crosslink curing by heat, light, etc. Its kind and composition may be selected in accordance with the use of the conductive film having carbon nanotubes mounted therein and the properties required thereof. It may be selected from among various kinds of highly transparent thermoplastic or thermosetting resins, for example, polyolefin resins such as polyethylene, polypropylene and polybutylene, polystyrene resins, halogenated polyolefin resins such as polyvinyl chloride, polyvinylidene chloride, polyvinyl fluoride and polytetrafluoroethylene, nitrile resins such as polyacrylonitrile, acrylic resins, methacrylic resins, polyvinyl ester resins, polyester resins, epoxy resins, urethane resins, urea resins, polycarbonate resins, polyether resins, polysulfone resins, polyimide resins, polyamide resins, polysilicone resins, cellulose resins and gelatin.

While the conductive film having the carbon nanotubes embedded by dispersion only in the surface portion of the resin film is formed by the method of the present invention, the carbon nanotubes (CNT's) embedded in the surface portion of the resin film may, for example, be of any of various diameters, lengths and aspect ratios, may be open at both ends or closed at least one end, or may be of the modified type, for example, having a middle opening or a solid portion, and may be single-walled or multi-walled carbon nanotubes. One of those kinds or two or more kinds may be employed.

Single-walled carbon nanotubes (SWCNT) are, for example, preferred from the standpoints of production, handling, etc.

According to the present invention, there is provided an apparatus for manufacturing a conductive film as described above, comprising at least:

1) a carbon nanotube substrate forming portion for dispersing carbon nanotube on a substrate surface;

2) a film forming portion for forming a resin film on the carbon nanotube substrate surface having the carbon nanotubes dispersed thereon; and

3) a film separating portion for separating the resin film which has been formed.

The above stepwise portions of the apparatus may be connected to one another on a batch basis, or may be constructed continuously with means for transportation, such as a belt conveyor.

The use of the method and apparatus as described above provides a conductive carbon nanotube film having a high conductivity as indicated by a surface resistance of or below 100 kΩ/□ in its surface portion which contains the carbon nanotubes. The resistance of its surface portion is the value of its surface resistance as measured by a four-terminal method.

According to the present invention, there is also provided a film having a resistance below 10 kΩ/□ or even below 3 kΩ/□.

According to a still more characteristic aspect of the present invention, there is provided a transparent conductive carbon nanotube film having a high transparency as indicated by a light transmittance (visible light) of 80% or above.

The conductive film of the present invention is not strictly limited in the thickness of its surface portion having carbon nanotubes enclosed and embedded therein by dispersion, but its thickness may be selected by considering e.g. the purpose of its use, its properties, its processability for use or its manufacturing efficiency. Usually, however, in view of its manufacture, handling as a film, conductivity, etc., its maximum thickness (t) in the vertical section of its surface portion having the carbon nanotubes enclosed and embedded therein by dispersion is preferably expressed as t/T<10% in relation to the maximum thickness (T) of the whole film.

According to the present invention, there is provided a flexible conductive film capable of perfect flexion in a flexing (bending) test. As regards its excellent flexing properties, the following is worthy of special mention.

According to the present invention, there is realized a film capable of withstanding 100 or more perfect flexions in a flexing test and having its surface portion which has the carbon nanotubes enclosed and embedded therein an electrical resistance not varying at all, or to any extent exceeding 10% when it is perfectly flexed.

According to the present invention, there is also realized a conductive carbon nanotube film having its surface portion which has the carbon nanotubes enclosed and embedded therein by dispersion of an electrical resistance not varying at all, or to any extent exceeding 10%, and a high adhesive strength, when a Scotch tape peeling test is conducted.

The flexing test and properties in the context of the present invention are defined as being based on the method which will be explained later in Example 3. The same is true of the Scotch tape peeling test.

According to the present invention, the surface portion of the resin film having the carbon nanotubes enclosed and embedded therein by dispersion may be defined as a patterned planar area in the whole plane of the resin film, and the conductive film so patterned is of great use in its development for application to, for example, a touch panel.

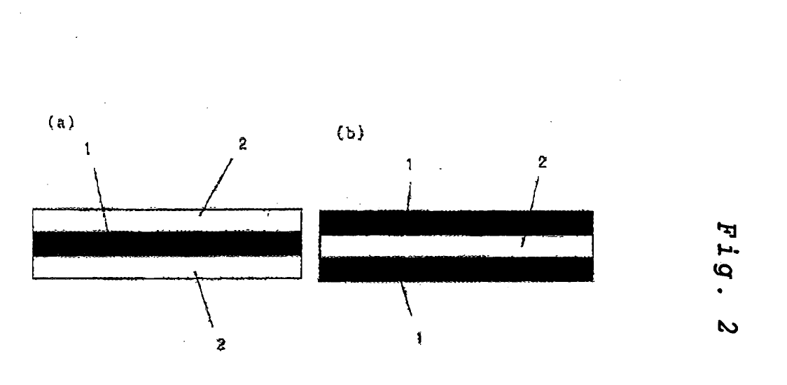

The conductive carbon nanotube film of the present invention may be employed as at least one of a multiplicity of layers forming a film. For example, FIG. 2 is a diagrammatic cross-sectional illustration of a conductive carbon nanotube film according to the present invention. According to FIG. 2(a), a transparent conductive carbon nanotube film is composed of a carbon nanotube-containing portion (1) having carbon nanotubes enclosed and embedded by dispersion in a resin film and non-carbon nanotube-containing portions (2) not having any carbon nanotube enclosed and embedded therein by dispersion, the carbon nanotube-containing portion (1) being held between the non-carbon nanotube-containing portions (2) disposed on both sides of the carbon nanotube-containing portion (1). The transparent conductive carbon nanotube film as described may be formed, for example, by covering both sides of a resin film having carbon nanotubes enclosed and embedded by dispersion therein with resin films not having any carbon nanotube enclosed and embedded by dispersion therein and uniting them together into a laminate. It may also be formed by employing two transparent conductive carbon nanotube films which have carbon nanotubes enclosed and embedded by dispersion therein only in the surface portions of the resin films and uniting them together into a laminate at their surface portions which have the carbon nanotubes enclosed and embedded therein. The transparent conductive carbon nanotube film formed as described has high conductivity and high transparency, too.

According to FIG. 2(b), carbon nanotube-containing portions (1) are disposed on both sides of a non-carbon nanotube-containing portion (2) and the non-carbon nanotube-containing portion (2) is held between the carbon nanotube-containing portions (1). The transparent conductive carbon nanotube film as described may be formed, for example, by covering both sides of a resin film which does not have any carbon nanotube enclosed and embedded by dispersion therein with resin films which have carbon nanotubes enclosed and embedded by dispersion therein and uniting them together into a laminate. It may also be formed by employing two transparent conductive carbon nanotube films which have carbon nanotubes enclosed and embedded by dispersion therein only in the surface portions of the resin films and uniting them together into a laminate at their surfaces opposite their surface portions which has the carbon nanotubes enclosed and embedded therein. The transparent conductive carbon nanotube film formed as described has high conductivity and high transparency, too.

The transparent conductive carbon nanotube film of the present invention can be applied and utilized effectively in various fields of industry, such as a touch panel, a reinforced polymer film, a contact lens, an electrode for e.g. a battery (particularly a positive electrode for a solar cell), a field-emitted electron source in the form of a transparent film, a flat panel display, a driving electrode for a liquid crystal display, an electromagnetic wave shielding material (used to prevent noise inside or outside a display or in a meter window), an aircraft material (a lightweight electromagnetic wave shield), a sensor electrode, a transparent heat-generating sheet (used e.g. to hold the working temperature of a liquid display designed for use in a cold place or prevent dew formation on the side mirrors of an automobile) and an artificial muscle, since it can be made highly conductive, highly transparent, and excellently flexible and adhesive, or can be patterned.

Examples will now be shown for description in further detail. The invention will, of course, not be limited by the following examples.

### EXAMPLES

### Example 1

A transparent conductive carbon nanotube film was formed by employing the following conditions and process:

Step (A):

Substrate:

A silicon substrate having a SiO₂ film with a thickness of 600 nanometers was used as the substrate (measuring 2 cm by 6 cm at maximum).

Method of Dispersing CNT:

Carbon nanotubes were directly synthesized on the silicon oxide substrate by a method of chemical vapor-phase synthesis. More specifically, an iron particle catalyst was first synthesized on the silicon oxide substrate by the method of H. Dai et al. (H. Dai, et al., Nano Letters Vol. 3, p. 157 (2003)). Then, the silicon oxide substrate having the iron particle catalyst fixed thereon was placed in a chemical vapor-phase reactor having a diameter of 1 inch and while it was heated to 750 degrees in an argon and hydrogen atmosphere, carbon nanotubes were grown on the substrate for 1 to 2 minutes, while ethylene gas was used as a carbon source. This method can make a highly dense and uniform single-walled carbon nanotube (SWCNT) network directly on the silicon oxide substrate. The carbon nanotube (SWCNT) network on the silicon oxide substrate has a surface resistance of 1 kΩ/□ or less. The surface resistance of the carbon nanotube network is adjustable from 1 kΩ/□ to infinite if the amount of the catalyst and the conditions of growth are adjusted.

Thickness of CNT Layer:

The thickness of SWCNT layer was estimated by measuring with a scanning atomic force microscope (made by National Instruments; DIMENSION). The control of the conditions of growth makes it possible to form ;a SWCNT layer having a thickness of from several nanometers to 10 micrometers.

Step (B):

Kind of Resin:

Polystyrene (having an average molecular weight of 280,000; Aldrich) was employed as the resin. The polystyrene was dissolved in toluene in a weight ratio (from 1:1 to 1:3) and degassed in a vacuum to prepare a resin material for a film.

Film Forming Method:

The polystyrene resin dissolved in toluene was used for spin coating (at 1,000 to 2,000 rpm, for 60 to 120 seconds, once or twice) and heated at 100 degrees for 30 minutes to form a film.

Film Thickness:

The film thickness was adjustable between 10 μm and 50 μm by selecting the mixing ratio of polystyrene and toluene and the number of revolutions, length of time and number of times for spin coating.

Step (C):

Method:

The formed polystyrene film easily allowed natural separation from the silicon substrate when its thickness was adequate (about 40 micrometers). When natural separation is difficult, the separation between the polystyrene film and the silicon substrate is possible if the sample is left to stand overnight in diluted fluoric acid (5%) and the resulting oxide layer is etched. In either event, almost all of the carbon nanotubes are transferred to the polystyrene film without remaining on the silicon substrate.

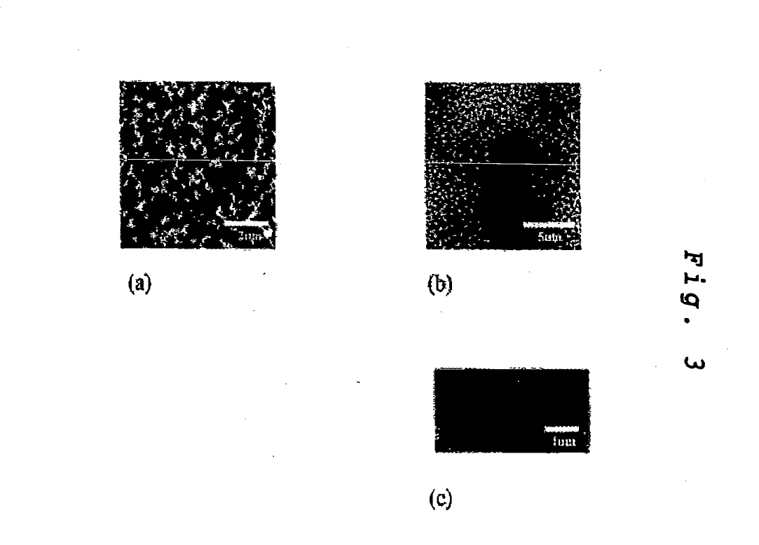

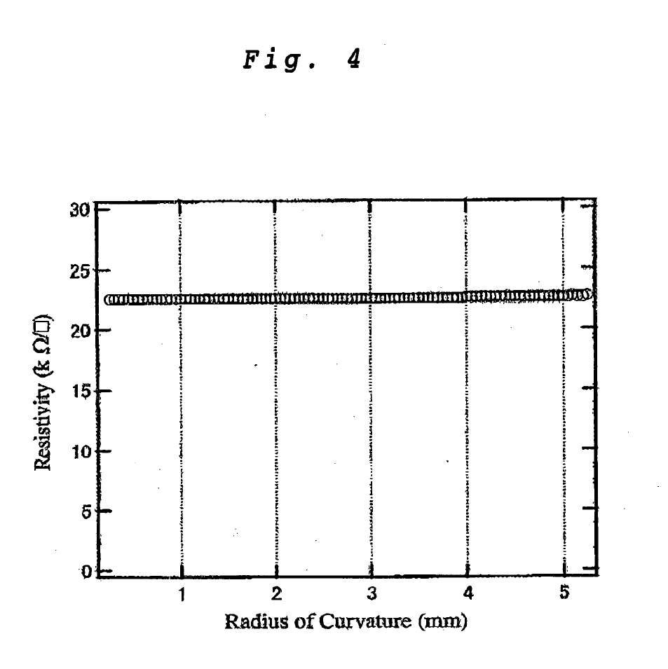

FIG. 3 shows atomic force microscope images of the surfaces of a transparent conductive carbon nanotube film and the state of carbon nanotubes as observed at various steps of manufacture of the transparent conductive carbon nanotube film. FIG. 3(a) shows the state of the carbon nanotubes as dispersed on a substrate at step (A). It reveals a uniform and dense network of carbon nanotubes formed in the surface portion. FIG. 3(b) shows the state of the surface of a resin film separated at step (C) and FIG. 4(c) shows the state of the surface of a substrate separated at step (C). The two figures reveal the perfect migration (transfer) of carbon nanotubes from the substrate to the resin. They also show the presence of a densely united network of carbon nanotubes enclosed and embedded by dispersion in the surface portion of the resin.

The transparent conductive carbon nanotube film was examined for its surface resistance, light transmittance and electron transport properties in relation to its flexion. The results are shown in FIGS. 4, 5 and 6, respectively.

FIG. 4 shows the surface resistance of the transparent conductive carbon nanotube film in relation to its flexion. The film hardly showed any change in conductivity even when it was curved to a radius of curvature up to 0.25 mm. At 0.25 mm, the film itself yielded and was broken.

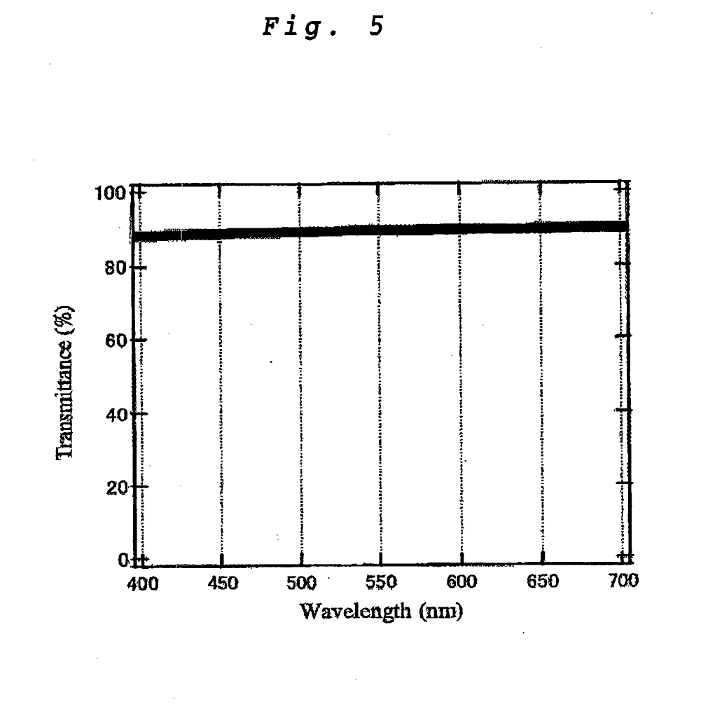

FIG. 5 shows the results obtained by measuring the visible light transmittance of the transparent conductive carbon nanotube film having a high conductivity as indicated by a surface resistance of 20 kΩ/□. It reveals a constant and high transparency (88%) throughout the whole visible region. A resin film not having any carbon nanotube enclosed and embedded therein showed a light transmittance of 90%.

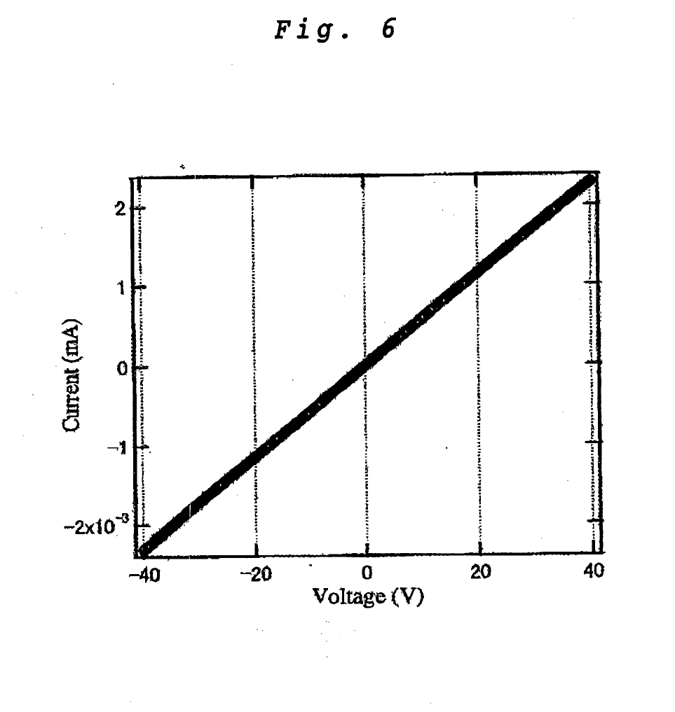

FIG. 6 shows the results obtained by measuring the electron transport property of a 2 cm square transparent conductive carbon nanotube film having a surface resistance : of 20 kΩ/□. It revealed ideal ohmic characteristics at up to 40 V. The transparent conductive carbon nanotube polystyrene films which could be formed as described above included one having a surface resistance of 4 kΩ/□.

### Example 2

Conductive carbon nanotube films were manufactured by using various kinds of resins by the same method as in Example 1.

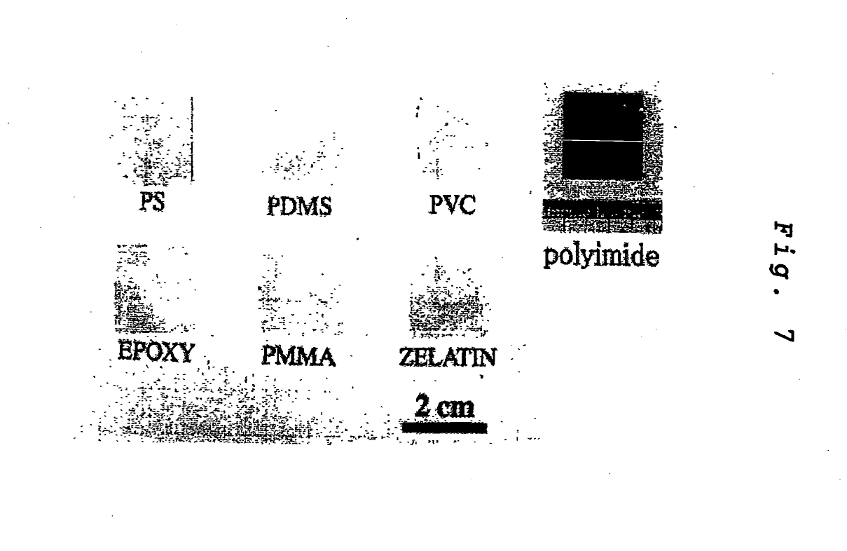

FIG. 7 shows the appearance of the conductive films as obtained. The symbols in the figure mean:

PS: polystyrene

PDMS: polydimethylsiloxane

PVC: polyvinyl chloride

EPOXY: epoxy resin

PMMA: polymethyl methacrylate

ZELATIN: gelatin

Polyimide: polyimide

The conditions under which the above conductive PVC film was formed are shown below by way of example.

Di-2-ethylhexyl phthalate (also called dioctyl phthalate, Di-2-ethylhexyl phthalate, C₆H₄(COOC₈H₁₇)₂, Kanto Chemical Co., Inc., 99.5%) was added 10-20% by weight as a plasticizer to a PVC powder (Aldrich, M_{w}=43,000), followed by the addition of cyclohexanone (Cyclohexanone, C₆H₁₀O, Wako Pure Chemical Industries, Ltd., 99.0%) about 2-4 times the volume. They were stirred for 12-24 hours by a magnetic stirrer to form a uniform solution.

As a standard, spin coating was performed at 500 rpm for 30 sec. on the substrate. It was dried by 2-5 hours of heating at 60° C. on a hot plate.

Ones having surface resistance and light transmittance (at 550 nm) as shown in Table 1 below were, for example, realized as conductive PVC films.

TABLE 1

| Case | Surface resistance | Transmittance |
|---|---|---|
| No. | (kΩ/□) | (%) |
| 2-1 | 3.5 | 83 |
| 2-2 | 2.7 | 72 |
| 2-3 | 2.2 | 75 |

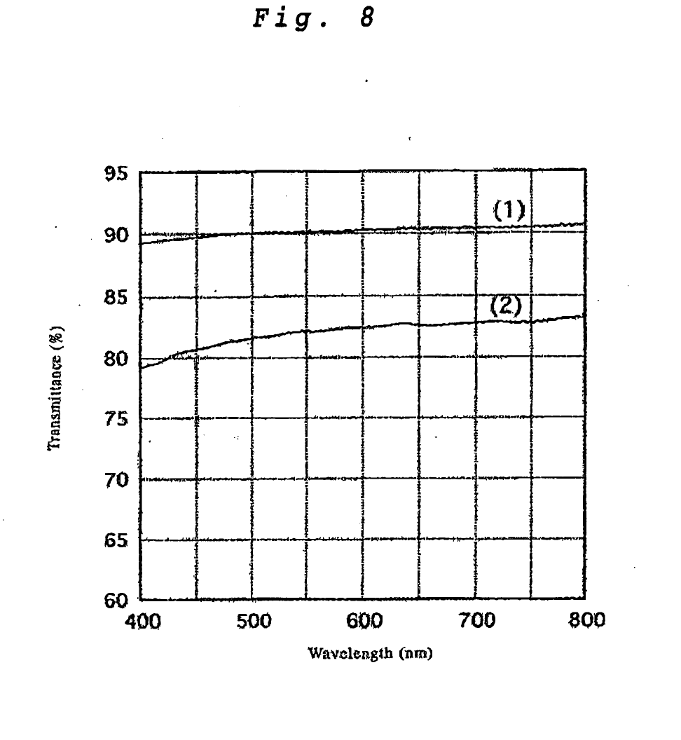

FIG. 8 shows the wavelength dependence of the light transmittance of the transparent conductive carbon nanotube film shown as Case No. 1 in Table 1. In the figure, (1) shows the transmittance of the PVC film itself, and (2) that of the SWCNT-PVC film. FIG. 8 testifies that it has a very constant light transmittance property in the visible region.

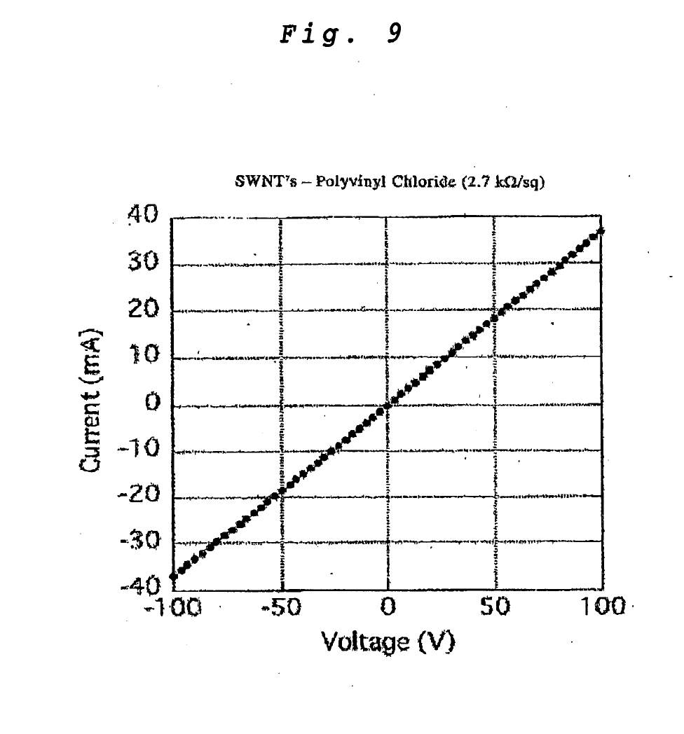

FIG. 9 shows the electrical transport property of the SWCNT-PVC film (2 cm square) shown as Case No. 2-2 in Table 1.

Table 2 shows by way of example the properties of conductive films of other resins.

TABLE 2

| Case | | Surface resistance | Transmittance |
|---|---|---|---|
| No. | Resin | (kΩ/□) | (%) |
| 2-4 | PDMS | 4.1 | 86 |
| 2-5 | ZELATIN | 6.8 | 74 |
| 2-6 | PS | 4 | 80 |
| 2-7 | PVC | 3.2 | 73 |
| 2-8 | PMMA | 2.6 | 75 |
| 2-9 | EPOXY | 4.7 | 43 |
| 2-10 | PVC | 3.5 | 82 |

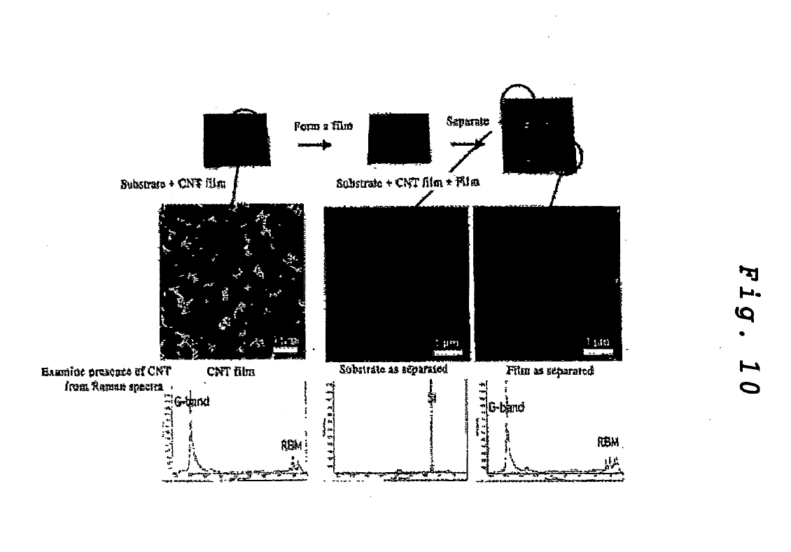

FIG. 10 shows the atomic force microscope images and Raman spectra of a conductive PVC film as formed by the method described above using the same substrate as in Example 1 and the film as separated from the substrate.

The resin is PVC and while the film has a thickness of 50 μm, the SWCNT layer has a thickness of 100-200 nm.

It is evident from FIG. 10 that SWCNT's did not remain on the substrate as separated, but were transferred to the resin film separated therefrom by being integrally enclosed and embedded therein.

It was confirmed that not to speak of, for example, the above cases, it was possible to form from various kinds of resins films having a thickness of 1 to 5,000 μm with SWCNT layers having a thickness of 30 to 2,000 nm.

### Example 3

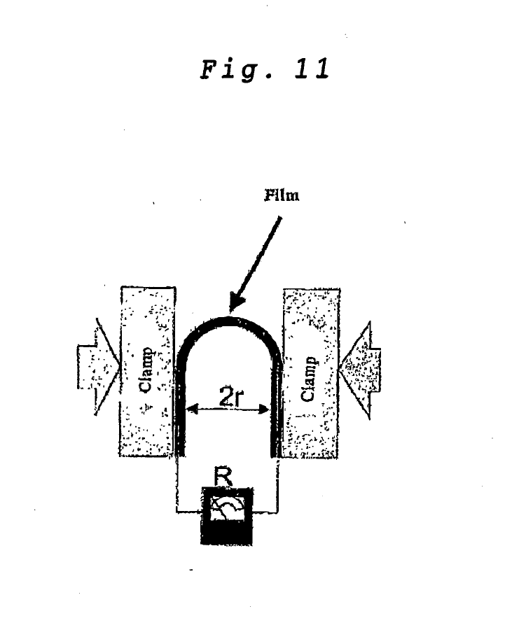

The SWCNT-PVC film according to Case No. 2-3 in Example 2 was examined for its flexibility and any change caused to its surface resistance by flexing by the flexing (bending) test as shown in FIG. 11.

A 20 mm square conductive carbon nanotube film was employed for the test. The film formed from the resin and having a thickness of 10 to 50 μm (usually 30 to 40 μm) was employed as a test specimen. The film was coated at both ends with an electrically conductive paste (product of Chemtronics) having a width of about 2 mm and defining an electrode. The film was curved with its single-walled carbon nanotube layer facing outwards was placed between clamps and was fixed with a double-sided adhesive tape. Finally, the electrodes at both ends of the film were connected to both terminals of a resistance meter. A gold or copper wire (0.2 mm in diameter) and the conductive paste mentioned above were used for their connection.

The flexing test was conducted by tightening the clamps gradually and measuring the distance between the clamps (2r in FIG. 10) and the value of resistance. The distance 2r between the clamps is equal to the diameter of the curved film. Therefore, the bending radius r of the film can be calculated as r=2r/2. The results are plotted in FIG. 11. The test was continued until the clamps were completely tightened, i.e. until the bending radius became 0 mm.

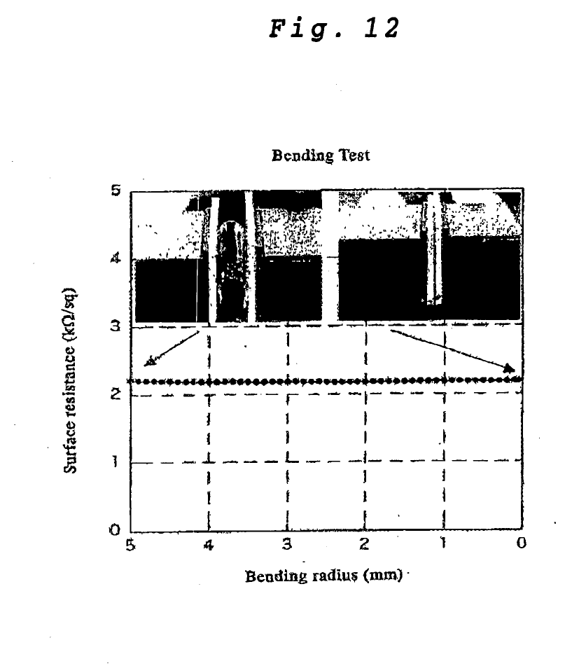

The device as described above was used for a cyclic test, too. After the clamps were tightened to flex the film into a bending radius of 1 mm and its resistance was measured, it bending radius was returned to 5 mm. This was counted as one cycle and 100 cycles were repeated and changes in resistance were plotted in comparison with the resistance before bending (FIG. 12).

According to the test, Case No. 2-3 allowed perfect flexion, i.e. the right and left bent segments of the film specimen in FIG. 11 could be brought into surface contact with each other and thereby realize a bending radius (r) of substantially 0 (zero), while the SWCNT-PS film according to Example 1 yielded and was broken at a bending radius (r) of 0.25 mm.

It is confirmed that the SWCNT-PVC film does not change in surface resistance despite its bending radius (r) varied by its flexion and despite even its perfect flexion, as shown in FIG. 12.

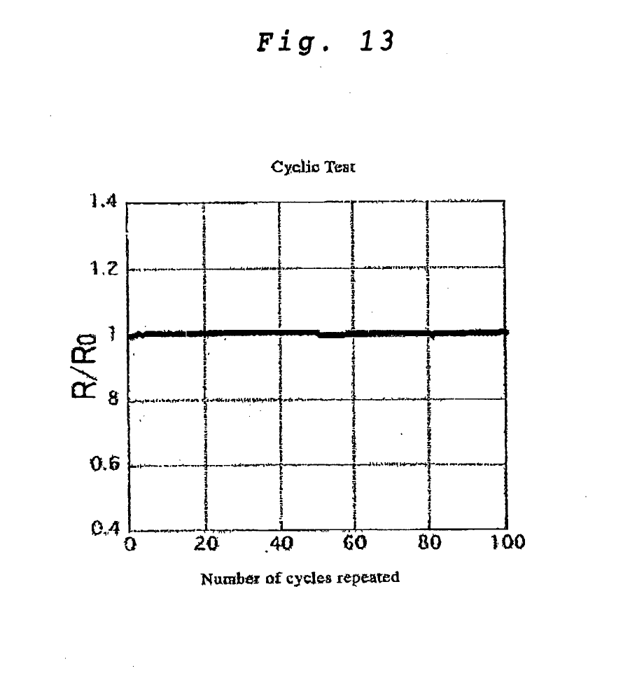

It is also confirmed that the bending test can be repeated for perfect flexion, for example, 100 times, without causing any change in resistance, as shown in FIG. 13.

It is evident that at least 100 times of repetition can be made without causing any change.

Moreover, a Scotch tape test was conducted to examine the adhesive property of the SWCNT's enclosed and embedded in the PVC resin.

The Scotch tape test was conducted under the following conditions.

A 20 mm square conductive carbon nanotube film was employed for the test. The film was formed from the resin and had a thickness of about 50 μm. The film was coated at both ends with an electrically conductive paste having a width of about 2 mm and defining an electrode. A gold or copper wire (0.2 mm in diameter) was bonded to the electrodes with the conductive paste and connected to both terminals of a resistance meter.

Then, a Scotch tape (product of 3M) having a width of 1.2 mm and a length of 15 mm was stuck to a side of the film on which the single-walled carbon nanotube layer existed. After it was pressed against the film with the tips of tweezers, the tape was peeled off and measurement was made for any change caused in resistance by the tape.

As a result, it was confirmed that the test did not cause any change in surface resistance, but that the SWCNT's were rigidly fixed to the PVC film by being enclosed and embedded therein.

### Example 4

SWCNT-PVC conductive films were manufactured by changing the substrate of Case No. 2-3 in Example 2 to niobium (Nb), stainless steel (SUS) and a nickel-chromium alloy, respectively. The films were substantially equal in properties.

As regards a process for manufacture, the metallic substrates were relatively inexpensive, easy to upgrade, flexible, and easy to separate from even a hard film.

### Example 5

A SWCNT layer was formed by plating instead of the CVD method employed for forming the SWCNT layer at step (A) in Example 1.

A single-walled nanotube dispersion was prepared in accordance with the literature of Penicaud et al. (JACS, 2005, Penicaud et al., Journal of American Chemical Society 127, 8-9). In a brief summary, a tetrahydrofuran solution of metallic sodium and naphthalene was prepared in a globe box, single-walled nanotubes were added therein and it was stirred for one day The residue obtained by filtering the supernatant at a reduced pressure (single-walled carbon nanotubes) was washed in tetrahydrofuran and dispersed in dimethylformamide. Then, cohesive matter was removed by centrifugal separation.

Aluminum plates each having a width of 1 cm and a length of 4 cm were placed as electrodes in the single-walled nanotube dispersion as obtained. The electrodes had a spacing of 1 mm therebetween. When it was left to stand for 18 hours after a voltage of 5 V was applied, a SWCNT film having a thickness of 1 μm or less was formed on the positive electrode. This treatment was carried out in an anaerobic atmosphere.

Then, conductive films having SWCNT's enclosed and embedded in resins, such as PS and PVC, were produced in accordance with steps (B) and (C). It was confirmed that they were comparable in properties to the Examples described above.

### Example 6

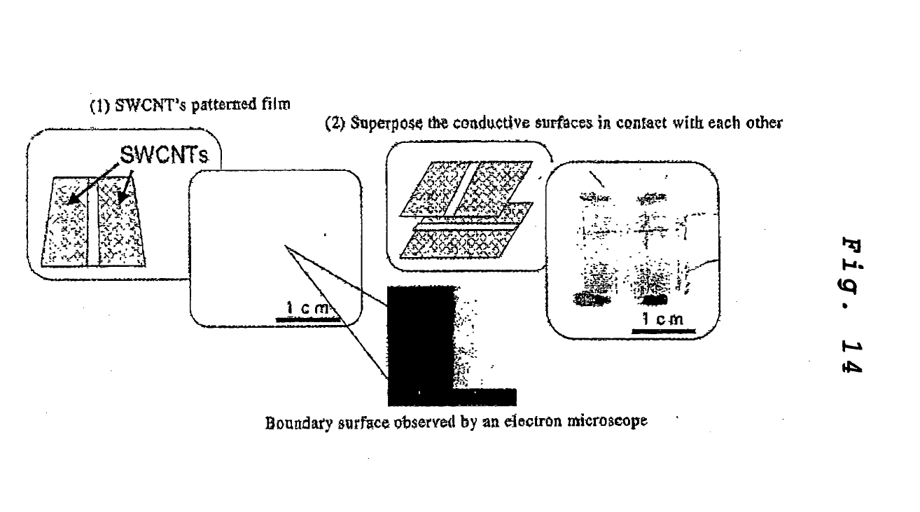

Patterns were formed on SWCNT conductive films as shown in FIG. 14, and their conductive sides were superposed on each other to form a touch panel.

The kind of resin was polyvinyl chloride, the film thickness was 40 to 80 μm (each 20 to 40 μm) and the thickness of the single-walled carbon nanotube layer was 200 to 300 nm. The method of its manufacture was as follows:

Fine iron particles were disposed as a catalyst so as to divide a patterned planar area on a 20 mm square silicon substrate having a 600 nanometer oxide film formed thereon. The disposition of the catalyst was performed after the substrate had been masked in some way or other. No iron particles are disposed in any masked region. According to the touch panel of the present Example, a tape measuring 2 by 20 mm was stuck as a mask for dividing the substrate. Then, an iron particle catalyst was synthesized on the substrate by the method of H. Dai et al (H . Dai et al., Nano Letters Vol. 3, p. 157 (2003)). The catalyst is disposed only on the substrate portions not masked. The mask tape is removed after the disposition of the iron particle catalyst. Then, the silicon oxide substrate having the iron particle catalyst disposed thereon was placed in a chemical vapor-phase reactor having a diameter of 1 inch and while it was heated to 750 degrees in an argon and hydrogen atmosphere, carbon nanotubes were grown on the substrate for 1 to 2 minutes, while ethylene gas was used as a carbon source. This method can make a highly dense and uniform single-walled carbon nanotube (SWCNT) network directly on the silicon oxide substrate, while no SWCNT grows on any portion masked when iron particles are disposed. Thus, a desired carbon nanotube pattern can be formed on the substrate.

According to the touch panel of the present Example, the substrate as grown has in its middle portion a band-shaped region formed by the mask applied thereto, having a width of 2 mm and lacking any single-walled carbon nanotube.

A PVC resin film was formed on the substrate by the same method as in Example 2.

A conductive carbon nanotube film was obtained by separating the resin film as formed from the substrate. The film as obtained has a pattern of single-walled nanotubes transferred from the substrate as they were, and has in its middle portion a region having a width of 2 mm and not having any single-walled carbon nanotube, i.e. an insulating zone not allowing electricity to flow, while the regions on both sides of the insulating zone where single-walled carbon nanotubes are present are conductive zones allowing electricity to flow.

A copper wire was bonded with a conductive paste to each of the two conductive zones of the conductive carbon nanotube film as obtained to form an electrode for resistance measurement.

A touch panel was made by preparing two conductive carbon nanotube films as described above and fixing them to a glass slide with their conductive zones so positioned as to cross each other at right angles. The two films are so positioned that their surfaces carrying the single-walled nanotubes may face each other. When the touch panel is depressed, the two conductive zones of the films facing each other contact each other to allow electricity to flow.

The trial product of touch panel as described showed a resistance dropping to about 15 kΩ when depressed, and rising to about 150 kΩ when released, whereby the recurrence of resistance by panel operation was confirmed.

### Example 7

A SWCNT conductive film was used for a heating element. The structural features of the heating element were as follows:

Kind of resin; Polyimide resin (Beyer M. L. RC-5057 (Wako Pure Chemical))

Film thickness: 20 μm

SWCNT thickness: 100-200 nm

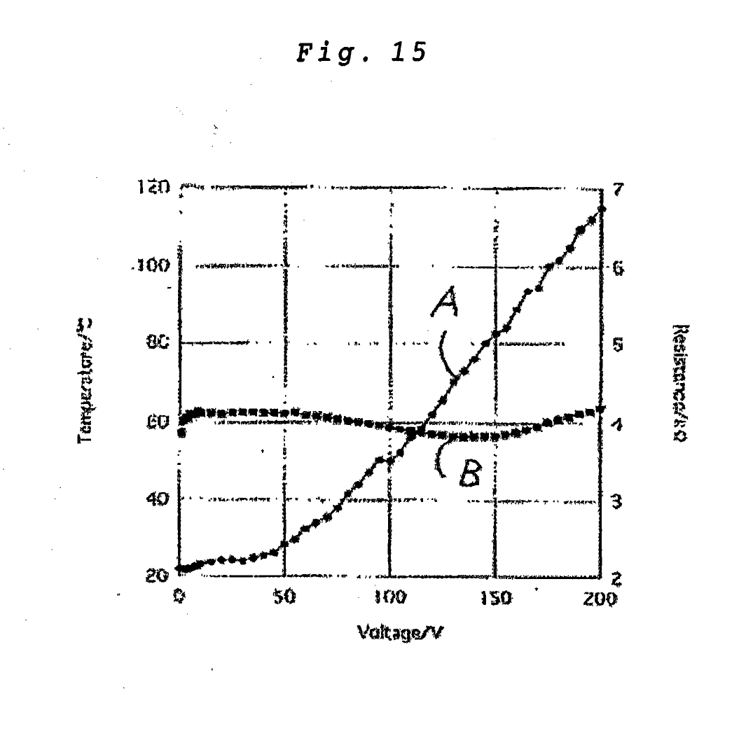

FIG. 15 illustrates variations in temperature (A) and resistance (B) of the heating element and shows the generation of heat with the application of voltage. The temperature. can be raised to of above 100° C. The use of a resin of high heat resistance makes it possible to realize a heater capable of being used up to a still higher temperature, and also a flexible heater.

In fact, heating to or above 100° C. made it possible to boil water in a glass container.

### INDUSTRIAL APPLICABILITY

The present invention as described above makes it possible to provide a film of high electrical conductivity by using only a small amount of carbon nanotubes and realize a flexible, highly transparent and conductive film. The manufacture therefor is simple and efficient according to the present invention.

According to the present invention, its outstanding features make it possible to realize conductive materials, heating elements, tough panels, etc. which are useful for various kinds of articles and apparatus, such as electrical and electronic machines and instruments, medical apparatus and machines.

1. A method of manufacturing a conductive carbon nanotube film, characterized by (A) dispersing carbon nanotubes on a substrate surface, (B) forming a resin film on the substrate surface on which the carbon nanotubes have been dispersed, and (C) separating the resin film as formed to produce a conductive film having the carbon nanotubes enclosed and embedded by dispersion or as a layer only in the surface portion of the resin film.

2. A method of manufacturing a conductive carbon nanotube film as set forth in claim 1, wherein the dispersion of the carbon nanotubes on the substrate surface by step (A) is carried out by at least one of the methods of growing, plating or scattering carbon nanotubes on the substrate surface, or casting a dispersion of carbon nanotubes.

3. A method of manufacturing a conductive carbon nanotube film as set forth in claim 1, wherein the forming of the resin film by step (B) is carried out by at least one of the methods of spin coating, roll coating, dip or like coating, or vapor-phase film forming.

4. A method of manufacturing a conductive carbon nanotube film as set forth in claim 1, wherein the carbon nanotubes are single-walled carbon nanotubes.

5. An apparatus for the manufacturing method as set forth in claim 1, comprising a carbon nanotube substrate forming portion for dispersing carbon nanotube on the substrate surface, a film forming portion for forming a resin film on the carbon nanotube substrate surface having the carbon nanotubes dispersed thereon and a film separating portion for separating the resin film which has been formed.

6. In a conductive film having carbon nanotubes enclosed and embedded by dispersion or as a layer only in the surface portion of a resin film, a conductive carbon nanotube film having a high conductivity as indicated by a surface resistance of or below 100 kΩ/□ in its surface portion which has the carbon nanotubes enclosed and embedded therein.

7. A conductive carbon nanotube film as set forth in claim 6, wherein the surface portion having the carbon nanotubes enclosed and embedded therein by dispersion has a resistance below 10 kΩ/□.

8. A transparent conductive carbon nanotube film as set forth in claim 6, characterized by having a high transparency as indicated by a light transmittance (visible light) of 80% or above.

9. A conductive carbon nanotube film as set forth in claim 6, wherein the surface portion having carbon nanotubes enclosed and embedded therein by dispersion has a maximum thickness (t) expressed as t/T<10% in relation to the maximum thickness (T) of the whole film.

10. A conductive carbon nanotube film as set forth in claim 6, wherein the carbon nanotubes are single-walled carbon nanotubes.

11. A conductive carbon nanotube film as set forth in claim 6, characterized by being perfectly flexible.

12. A conductive carbon nanotube film as set forth in claim 11, characterized by being capable of withstanding 100 or more perfect flexions in a flexing test.

13. A conductive carbon nanotube film as set forth in claim 11, characterized in that when it is perfectly flexed, the electrical resistance of the surface portion having the carbon nanotubes enclosed and embedded therein does not vary at all, or to any extent exceeding 10%.

14. A conductive carbon nanotube film as set forth in claim 6, characterized in that when a Scotch tape peeling test is conducted, the electrical resistance of the surface portion having the carbon nanotubes enclosed and embedded therein does not vary at all, or to any extent exceeding 10%, and that the carbon nanotubes enclosed and embedded therein by dispersion are high in adhesive strength.

15. A conductive carbon nanotube film as set forth in claim 6, wherein the surface portion of the resin film having the carbon nanotubes enclosed and embedded therein by dispersion is defined in a patterned planar area in the whole plane of the resin film.

16. A conductive carbon nanotube film composed of a multiplicity of layers including at least one layer formed by the conductive carbon nanotube film as set forth in claim 6.

17. A conductive carbon nanotube film as set forth in claim 16, wherein layers having carbon nanotubes enclosed and embedded therein by dispersion are stacked opposite each other so as to sandwich a resin layer not having any carbon nanotube enclosed and embedded therein by dispersion.

18. A conductive material having at least a part of its structure formed by the conductive carbon nanotube film as set forth in claim 6.

19. A conductive material as set forth in claim 18, characterized by having flexibility.

20. A heating element having at least a part of its structure formed by the conductive carbon nanotube film as set forth in claim 6.

21. A heating element as set forth in claim 20, characterized as a flexible heating element having flexibility.

22. A touch panel having at least a part of its structure formed by the conductive carbon nanotube film as set forth in claim 6.

23. A touch panel as set forth in claim 22, characterized as a flexible touch panel having flexibility.
